(19) United States
(12) Patent Application Publication
(10) Pub. No.: US 2012/0127336 A1
(43) Pub. Date: May 24, 2012

(54) IMAGING APPARATUS, IMAGING METHOD AND COMPUTER PROGRAM

(75) Inventors: Tetsuji UEZONO, Yokohama-shi (JP); Junzo SAKURAI, Yokohama-shi (JP)

(73) Assignee: AOF IMAGING TECHNOLOGY, CO., LTD., Hong Kong (CN)

(21) Appl. No.: 13/297,482

(22) Filed: Nov. 16, 2011

(30) Foreign Application Priority Data
Nov. 19, 2010 (JP) 2010-258676

(51) Int. Cl. H04N 9/73

(52) U.S. Cl. 348/223.1; 348/E09.051

(57) ABSTRACT

The present invention provides an imaging apparatus which, when a dynamic range is expanded, even if a subject is irradiated by a plurality of different light sources, can apply adequate white balances to respective light sources. The imaging apparatus captures two images from an image sensor at different exposures when a preview image, which is input from the image sensor but is not captured yet, includes an area which is irradiated by the different light sources and which comprises the different brightnesses. The imaging apparatus then composes a dark area of the one image captured at the over exposure and applied a white balance to and a bright area of the other image captured at the under exposure and applied a white balance to.

### CROSS-REFERENCE TO RELATED APPLICATION

The present application is related to, claims priority from, and incorporates by reference Japanese Patent Application No. 2010-258676 filed on Nov. 19, 2010.

### BACKGROUND OF THE INVENTION

1. Field of the Invention

The present invention relates to an imaging apparatus, an imaging method and a computer program.

2. Description of Related Art

In recent years, digital imaging apparatuses such as digital still cameras are put into practical use for processing an image signal of a captured subject as a digital signal. Although, with a digital imaging apparatus, CCD (Charge Coupled Device Image Sensor) type or CMOS (Complementary Metal Oxide Semiconductor) type image capturing elements are generally used, its dynamic range is substantially narrow compared to a photographic film. The dynamic range refers to a level at which an image signal can be obtained without collapse even when a multifold excessive beam is incident in case where there are bright portions and dark portions in a range of an image to be captured by an imaging apparatus.

When, for example, the brightness of an image capturing target settles in a predetermined range, it is possible to capture an image which well reflects a brightness difference by adjusting an exposure amount. By contrast with this, when the brightness difference of the image capturing target exceeds a predetermined range, even if the exposure amount is adjusted, “blocked-up shadows (under exposure)” where portions of a comparatively low brightness become black, or “over exposure (blown out highlights)” where portions of a comparatively high brightness become white inevitably occurs.

Hence, techniques are variously proposed which expand a dynamic range by composing images obtained by capturing images of a single subject at different exposures (shutter speeds).

For example, according to JP 2002-290824 A, a histogram is generated by capturing one image, and, if the number of pixels which are not saturated (which are not over-exposed) is a predetermined number or less, second and subsequent images are captured. Further, a technique is disclosed which generates a final image exceeding a dynamic range of an image capturing element by using one of the first, second or subsequent image based on R, G and B values of captured pixels.

Furthermore, for example, JP 2000-350220 A discloses a technique which captures image at an adequate exposure and under exposure and applies a white balance to images captured at respective exposures, and replaces a saturated portion of the image captured at the adequate exposure, with the image captured at the under exposure.

### SUMMARY OF THE INVENTION

When there are a plurality of light sources, while an adequate white balance gain is applied to one of the light sources, an inadequate white balance gain is applied to the other light sources. When the dynamic range is not expanded, an area to which an inadequate white balance gain is applied is generally shown very brightly or very darkly, and therefore, even if a final image is visually checked, a difference in the white balance does not particularly matter. However, as in JP 2002-290824 A, when the dynamic range is expanded, both of bright portions and dark portions are reproduced at an adequate exposure, and therefore a difference in the white balance cannot be ignored.

By contrast with this, according to the technique of JP 2000-350220 A, although the white balances can be applied to a low brightness area and high brightness area, respectively, there is actually a problem that the user needs to look at a scene to be captured to predict whether or not it is necessary to adjust a plurality of white balances. Even when there are bright portions and dark portions, the human eyes adapt to the bright portions and dark portions to easily look at, and therefore it is not easy for the user to look at a scene and decide whether or not it is necessary to adjust a plurality of white balances.

It is therefore an exemplary object of the present invention to provide an imaging apparatus, an imaging method and a computer program which, when a dynamic range is expanded, even if a subject is irradiated by a plurality of different light sources, can apply adequate white balances to a plurality of light sources.

According to an exemplary aspect of the present invention, an imaging apparatus comprises: an image sensor; a deciding unit which decides whether or not a preview image, which is input from the image sensor but is not captured yet, includes an area which is irradiated by different light sources and which comprises different brightnesses, based on a subject brightness and a color temperature of the preview image; an image capturing control unit which captures two images from the image sensor at different exposures when the deciding unit decides that the preview image includes an area defined above; and a composition unit which applies a white balance to one image captured at an over exposure, applies a white balance to the other image captured at an under exposure and composes a dark area of the one image captured at the over exposure and applied the white balance to and a bright area of the other image captured at the under exposure and applied the white balance to.

According to another exemplary aspect of the present invention, imaging method of an imaging apparatus comprising an image sensor, the method comprises: deciding whether or not a preview image, which is input from the image sensor but is not captured yet, includes an area which is irradiated by different light sources and which comprises different brightnesses, based on a subject brightness and a color temperature of the preview image; capturing two images from the image sensor at different exposures when it is decided that the preview image includes an area defined above; applying a white balance to one image captured at an over exposure; applying a white balance to the other image captured at an under exposure; and composing a dark area of the one image captured at the over exposure and applied the white balance to and a bright area of the other image captured at the under exposure and applied the white balance to.

According to another exemplary aspect of the present invention, a computer program which causes a computer to execute image capturing processing of an imaging apparatus comprising an image capturing element, causing a computer to perform processing comprising: deciding whether or not a preview image, which is input from the image sensor but is not captured yet, includes an area which is irradiated by different light sources and which comprises different brightnesses, based on a subject brightness and a color temperature of the preview image; capturing two images from the image sensor at different exposures when it is decided that the preview image includes an area defined above; applying a white balance to one image captured at an over exposure; applying a white balance to the other image captured at an under exposure; and composing a dark area of the one image captured at the over exposure and applied the white balance to and a bright area of the other image captured at the under exposure and applied the white balance to.

According to the present invention, it is possible to provide an imaging apparatus, an imaging method and a computer program which, when, for example, a dynamic range is expanded, even if a subject is irradiated by a plurality of different light sources, can apply adequate white balances to a plurality of light sources.

### BRIEF DESCRIPTION OF THE DRAWINGS

Specific embodiments of the present invention will now be described, by way of example only, with reference to the accompanying drawings in which:

FIG. 1 is a block diagram illustrating a configuration example of an imaging apparatus according to an exemplary embodiment;

FIG. 2 is a block diagram illustrating a functional configuration example of the imaging apparatus;

FIG. 3A and FIG. 3B are views describing an example of detection of an isolated block;

FIG. 4 is a view illustrating an example of a histogram;

FIG. 5 is a view describing a specific example of expansion of a dynamic range and composition of multiple white balances; and

FIG. 6 is a flowchart describing image capturing condition decision processing.

### DETAILED DESCRIPTION OF THE PREFERRED EMBODIMENTS

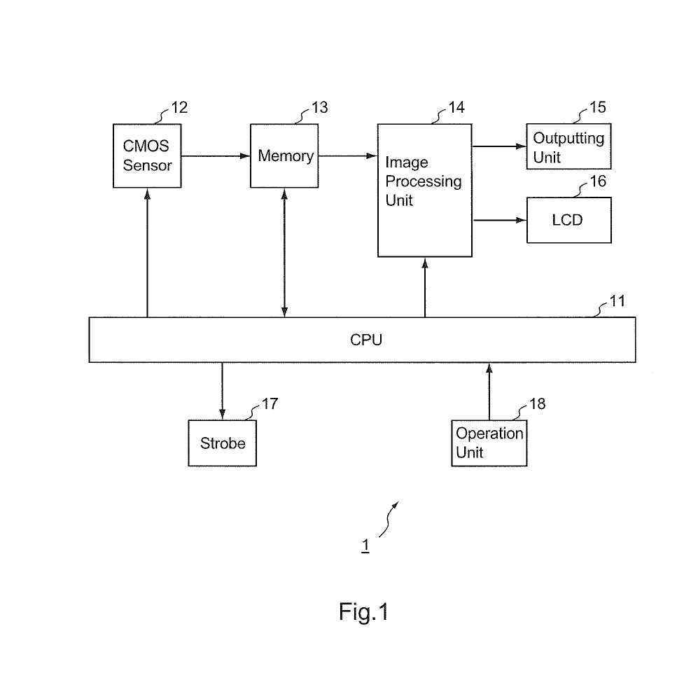

FIG. 1 is a block diagram illustrating a configuration example of an imaging apparatus 1 according to an exemplary embodiment. The imaging apparatus 1 is an apparatus such as a digital still camera, digital video camera or mobile telephone having a function of capturing still images.

A CPU (Central Processing Unit) 11 executes a predetermined computer program, and controls the entire operation of the imaging apparatus 1. As described below, for example, the CPU 11 detects a scene which the user intends to capture an image of, before a shutter button is pushed. An image capturing scene is detected based on a live preview image which is taken in by a CMOS (Complementary Metal Oxide Semiconductor) sensor 12. The CPU 11 decides whether the detected scene requires expansion of the dynamic range and causes a mismatch of white balances, requires expansion of the dynamic range and does not cause a mismatch of white balances, or does not require expansion of the dynamic range (hereinafter, this processing will be referred to as “scene decision processing”). Further, the CPU 11 performs image capturing according to an optimal method matching the decision result.

The CMOS sensor 12 photoelectrically converts light which is taken in by a lens and A/D (Analog/Digital) converts an image signal obtained by photoelectric conversion. The CMOS sensor 12 stores image data obtained by A/D conversion, in a memory 13.

An image processing unit 14 reads as a live preview image from the memory 13 the image which is input from the CMOS sensor 12 and stored in the memory 13 before the shutter button is pushed, that is, the image is not captured yet, and displays this image on a LCD (Liquid Crystal Display) 16. Further, the image processing unit 14 applies various image processings such as dynamic range expansion processing, white balance processing and outline emphasis processing, to the image obtained as a result of image capturing according to a detection result of an image capturing scene which the user intends to capture. The image processing unit 14 outputs the image to which various image processings are applied, to an outputting unit 15 or the LCD 16. Information showing a detection result of an image capturing scene is supplied from the CPU 11 to the image processing unit 14.

The outputting unit 15 stores the captured image supplied from the image processing unit 14, in a memory card which is attachable to the imaging apparatus 1, or transmits the captured image to an external apparatus. The LCD 16 displays the live preview image or captured image supplied from the image processing unit 14.

The strobe 17 emits light according to control by the CPU 11, and irradiates light on the subject. An operation unit 18 has various buttons such as the shutter button, and outputs a signal showing content of a user's operation, to the CPU 11 when a button is operated.

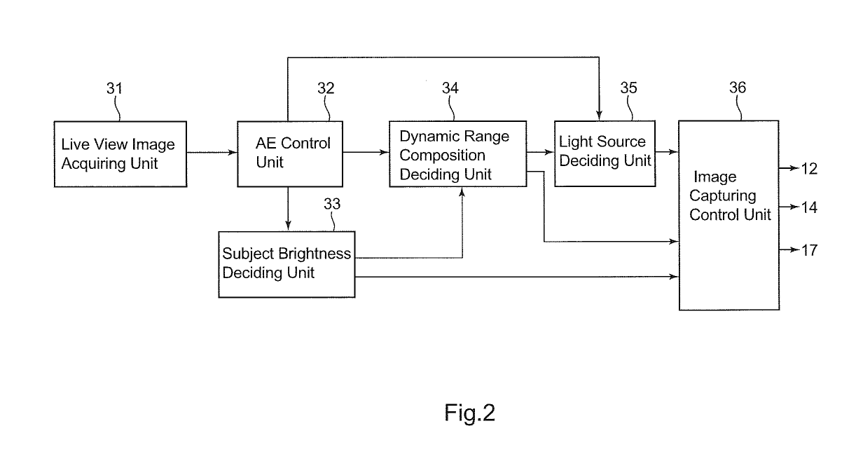

FIG. 2 is a block diagram illustrating a functional configuration example of the imaging apparatus 1 when scene decision processing is performed and an image is captured according to a method matching this decision result. At least part of functional units illustrated in FIG. 2 is realized by executing a predetermined computer program by the CPU 11 in FIG. 1.

As illustrated in FIG. 2, the imaging apparatus 1 comprises a preview image acquiring unit 31, an AE control unit 32, a subject brightness deciding unit 33, a dynamic range composition deciding unit 34, a light source deciding unit 35 and an image capturing control unit 36.

The preview image acquiring unit 31 acquires image data stored in the memory 13 before the shutter button is pushed, as a live preview image, and supplies the acquired live preview image to the AE control unit 32.

The AE control unit 32 divides the live preview image into a plurality of blocks, calculates an average value of R, G and B of each block, respectively, and supplies the calculated average values of R, G and B to the subject brightness deciding unit 33 and light source deciding unit 35. The block refers to a divided area including a group of a plurality of pixels, and is obtained by dividing one live preview image into 12 blocks by 8 blocks.

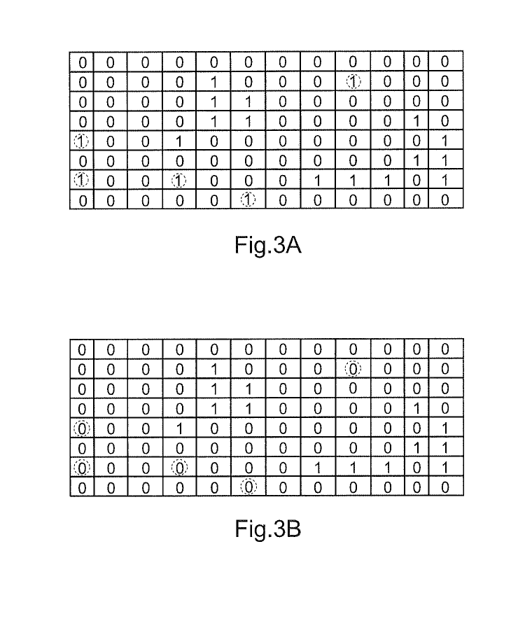

The AE control unit 32 further converts the calculated average value of R, G and B into a brightness value Y. The AE control unit 32 finds the number of pixels (blocked-up shadow amount) having the brightness value Y of the image equal to or less than the first threshold and finds the number of pixels (over exposure amount) having the brightness value Y of the image equal to or more than a second threshold which is greater than the first threshold, and sets the flag to 1 in a block having the blocked-up shadow amount or over exposure amount equal to or more than the third threshold and sets the flag to 0 in a block having the blocked-up shadow amount or over exposure amount less than the third threshold. By this means, as illustrated in, for example, FIG. 3A, the flag 0 or 1 is set to each block.

The AE control unit 32 sets the flag in each block, and detects the isolated block. Detection of the isolated block refers to removing a block (reversing the flag) when the flag of the block of interest does not match with flags of eight blocks adjacent to the block (isolated from the flags of the eight blocks adjacent to this block). When an isolated block is detected, as illustrated in, for example, FIG. 3B, the blocks surrounded by round circles in FIG. 3A are removed. In addition, in case of blocks at ends or corners of the image, if these blocks do not match with the 5 or 3 adjacent blocks, these blocks are decided to be isolated.

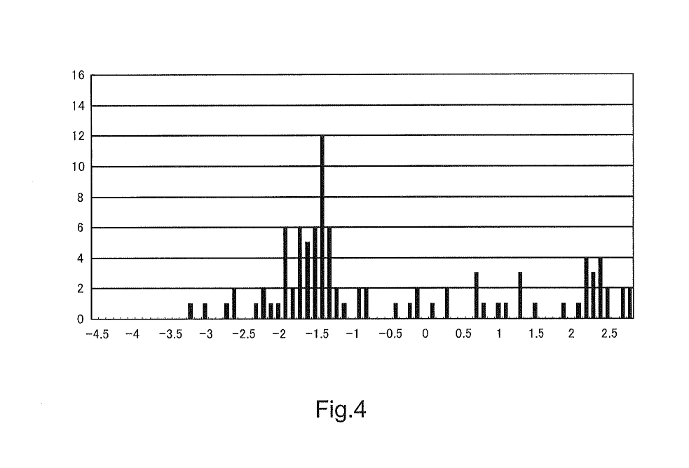

The AE control unit 32 further detects isolated blocks and then converts the brightness value Y of each block and adequate exposure value in EV units, and calculates the brightness value Y in EV units per block and generates a histogram using 12×8=96 items of data. By this means, the histogram illustrated in, for example, FIG. 4 is generated. In FIG. 4, the horizontal axis indicates the exposure correction amount (shift amount from adequate exposure), and the vertical axis indicates the frequency. Meanwhile, plus of the exposure correction amount means an over exposure with respect to the adequate exposure value, and minus of the exposure correction amount means an under exposure with respect to the adequate exposure value.

The AE control unit 32 supplies the generated histogram information to the dynamic range composition deciding unit 34.

The subject brightness deciding unit 33 acquires (extracts) a brightness level of a subject based on the average value of R, G and B supplied from the AE control unit 32, and decides whether or not the brightness level is a predetermined threshold or more. The subject brightness deciding unit 33 supplies a decision result to the dynamic range composition deciding unit 34 when the brightness of the subject is a brightness level equal to or greater than a predetermined threshold, and supplies a decision result to an image capturing control unit 36 when the brightness of the subject is less than a predetermined threshold.

From the histogram information supplied from the AE control unit 32, the dynamic range composition deciding unit 34 decides whether or not there is a predetermined number of non-isolated blocks (over exposure areas) or more having the exposure correction amount greater than a predetermined value (for example, +1.5), further decides whether or not there is a predetermined number of non-isolated blocks (blocked-up shadow areas) or more having the exposure correction amount smaller than a predetermined value (for example, −1.5), and moreover decides whether or not there is a predetermined number of blocks or less having the exposure correction amount in a predetermined range (near the adequate exposure value). According to these decisions, it is possible to decide whether or not an image includes a distribution in bright portions and dark portions.

The dynamic range composition deciding unit 34 supplies a decision result to the light source deciding unit 35 when all of the above three decision conditions are satisfied, and supplies a decision result to the image capturing control unit 36 when one of the conditions is not satisfied.

The light source deciding unit 35 extracts the color temperature of each block based on the average value of R, G and B supplied from the AE control unit 32, and decides whether or not there is a predetermined number of non-isolated blocks or more having the color temperature in a predetermined range (for example, 4500 K to 6000 K) and decides whether or not there is a predetermined number of non-isolated blocks or more having the color temperature in a predetermined range (for example, 7000 K to 9000 K) and brightness value Y less than a predetermined value (for example, 100). According to these decisions, it is possible to decide whether or not an image includes direct light of the sun and scattering light due to reflection. That is, it is possible to decide whether or not there are areas irradiated by light from different light sources.

The light source deciding unit 35 supplies the above two decision results of the decision conditions to the image capturing control unit 36.

The image capturing control unit 36 sets an image capturing mode based on the decision result supplied from the subject brightness deciding unit 33, the decision result supplied from the dynamic range composition deciding unit 34 and the decision result supplied from the light source deciding unit 35, and, when the user pushes the shutter button, controls the CMOS sensor 12 and strobe 17 to capture an image according to the set image capturing mode.

For example, when a mode of expanding the dynamic range and composing multiple white balances is set, the image capturing control unit 36 controls the CMOS sensor 12 to capture two images at different exposures, and controls the image processing unit 14 to perform white balance processing of and compose the two captured images.

Further, for example, when a mode of only expanding the dynamic range is set, the image capturing control unit 36 controls the CMOS sensor 12 to capture two images at different exposures and controls the image processing unit 14 to compose the two captured images.

Furthermore, for example, when a normal mode which does not expand the dynamic range is set, the image capturing control unit 36 controls the CMOS sensor 12 to capture one image.

Thus, when the mode of expanding the dynamic range and composing multiple white balances is set, the imaging apparatus 1 captures a plurality of images at different exposures, applies adequate white balances to a plurality of captured images and composes the images.

Switching of processing of image processing unit 14 will be described. In the image processing unit 14, processing is switched according to the decision results from the subject brightness deciding unit 33, dynamic range composition deciding unit 34 and light source deciding unit 35.

Two images are captured at different exposures, and the two captured images are supplied to the image processing unit 14. When, for example, an image of a building is captured outdoor, the image processing unit 14 applies a white balance to a portion in which there is an object of an image captured at the over exposure, applies a white balance to the portion of the blue sky of an image captured at the under exposure, and the image of the portion which is captured at the over exposure, to which the white balance is applied and in which there is the object, and the image of the portion of the blue sky which is captured at the under exposure and to which the white balance is applied are composed to generate one composition image.

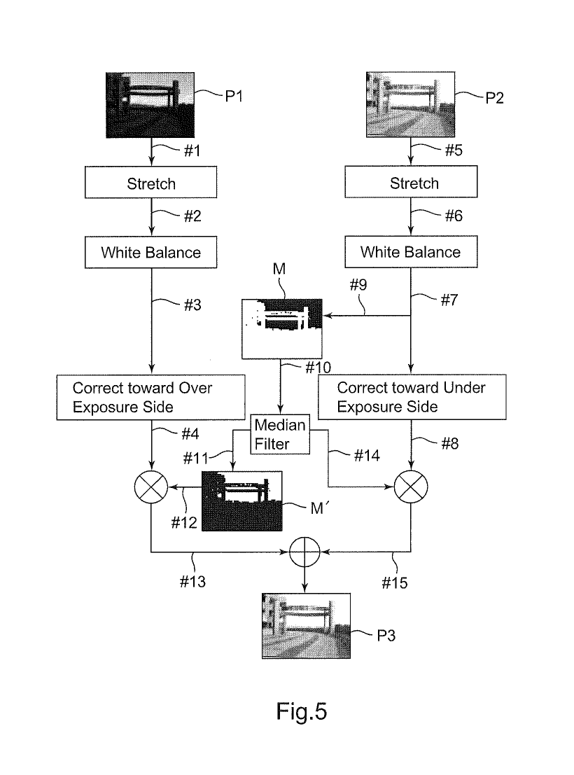

FIG. 5 is a view describing a specific example of expansion of the dynamic range and composition of multiple white balances. An image P1 illustrated in FIG. 5 is captured at the under exposure (exposure correction amount ΔEv=−2Ev), and the image P2 is captured at the over exposure (exposure correction amount ΔEv=2Ev).

The image P1 captured at the under exposure is stretched as indicated at the destination of an arrow #1 (although this processing is performed if the image is compressed according to A-Law, this processing needs not to be performed if the image is not compressed), and the white balance is applied to the image as indicated at the destination of an arrow #2. Further, as indicated at the destination of the arrow #3, the image which is captured at the under exposure and to which the white balance is applied is corrected toward the over exposure side such that the exposure becomes adequate. That is, the image is set ΔEv=−ΔEv (=2 Ev=−(−2 Ev (exposure correction amount))) toward an over exposure value compared to the adequate exposure value. The image which is corrected to an adequate exposure is supplied to a multiplier as indicated at the destination of an arrow #4.

By contrast with this, the image P2 captured at the over exposure is stretched as indicated at the destination of an arrow #5 (although this processing is performed when the image is compressed according to A-Law, this processing needs not to be performed when the image is not compressed), and the white balance is applied as indicated at the destination of an arrow #6. In addition, the white balance which is suitable for a non-saturated area (area of pixels having a lower value than a certain level) is applied. Further, as indicated at the destination of the arrow #7, the image which is captured at the over exposure and to which the white balance is applied is corrected toward the under exposure side such that the exposure becomes adequate. That is, the image is set ΔEv=−ΔEv (=2 Ev=−(−2 Ev (exposure correction amount))) toward an under exposure value compared to the adequate exposure value. The image which is corrected to an adequate exposure is supplied to a multiplier as indicated at the destination of an arrow #8.

Further, as indicated at the destination of the arrow #9, mask data M is generated from pixels having a greater pixel value of an image which is captured at the over exposure and to which the white balance is applied than a predetermined threshold (for example, pixel value 700 in 10 bit image), and pixels having a pixel value which is not greater than a predetermined threshold. Noise is removed from the generated mask data M by a median filter as indicated at the destination of an arrow #10, and the mask data M is reversed as indicated at the destination of an arrow #11. The reversed mask data M′ is supplied to the multiplier as indicated at the destination of an arrow #12. This multiplier extracts an image of the portion of the blue sky from the image P1 to which the white balance is applied and which is corrected to an adequate exposure and mask data M′, and supplies the image to an adder as indicated at the destination of an arrow #13.

The mask data M from which noise is removed by the median filter is supplied to the multiplier as indicated at the destination of an arrow #14. This multiplier extracts an image of a portion in which there is an object, from the image P2 to which the white balance is applied and which is corrected to an adequate exposure and mask data M, and supplies the image to the adder as indicated at the destination of an arrow #15.

By this means, the adder composes the image of the portion of the blue sky which is captured at the under exposure and to which the white balance is applied and an image of the portion which is captured at the over exposure, to which the white balance is applied and in which there is an object to generate one composition image P3. Further, the image processing unit 14 performs various image processings of the composition image P3.

When a plurality of images are captured at different exposures, and a plurality of captured images are supplied to the image processing unit 14, the image processing unit 14 composes the image of the portion which is captured at the over exposure and in which there is an object and an image of the portion of the blue sky which is captured at the under exposure to generate one composition image. Further, the image processing unit 14 performs various image processings of the composition image.

When one image is captured at an adequate exposure, and is supplied to the image processing unit 14, the image processing unit 14 performs various image processings of one image.

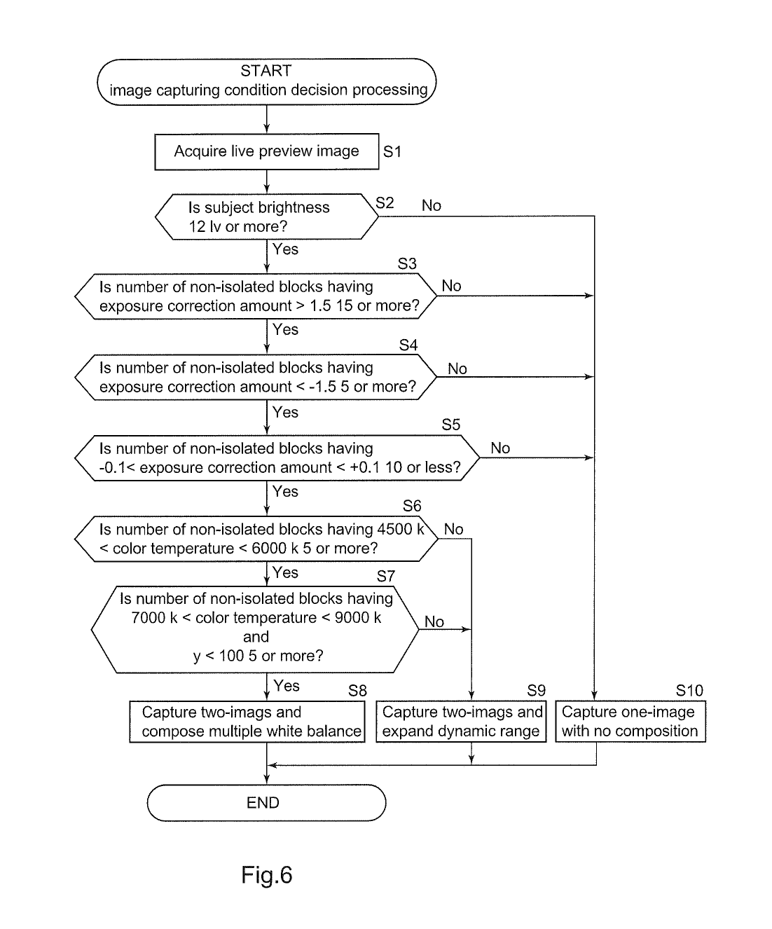

Image capturing condition decision processing which is executed by the imaging apparatus 1 will be described with reference to the flowchart of FIG. 6.

The image capturing control unit 36 controls the CMOS sensor 12 to acquire a live preview image. The acquired live preview image is stored in the memory 13, then is supplied to the live preview image acquiring unit 31, is read by the image processing unit 14 and is displayed on the LCD 16.

In step S1, the live preview image acquiring unit 31 acquires the live preview image, and supplies the acquired live preview image to the AE control unit 32. The AE control unit 32 divides the live preview image into a plurality of blocks, calculates the average value of R, G and B in each block, respectively, and supplies the calculated average value of R, G and B in each block to the subject brightness deciding unit 33 and light source deciding unit 35. Further, as described with reference to FIG. 3A, FIG. 3B and FIG. 4, the AE control unit 32 generates histogram information of the live preview image, and supplies the histogram information to the dynamic range composition deciding unit 34.

In step S2, the subject brightness deciding unit 33 acquires the brightness level of the subject based on the average value of R, G and B in each block supplied from the AE control unit 32, and decides whether or not the brightness level is 12 Lv (Light View) or more. In addition, the brightness of a sunny day is about 14 Lv. When the subject brightness level is 12 Lv or more, it is possible to decide that the image is captured outdoor during daytime.

When it is decided in step S2 that the brightness level of the subject is 12 Lv or more, the step proceeds to step S3, and the dynamic range composition deciding unit 34 decides whether or not the number of non-isolated blocks having the exposure correction amount greater than +1.5 is 15 or more, based on histogram information supplied from the AE control unit 32. That is, whether or not the image includes a bright portion (area) having a certain size or more is decided.

When it is decided in step S3 that the number of non-isolated blocks having the exposure correction amount greater than +1.5 is 15 or more, the step proceeds to S4, and the dynamic range composition deciding unit 34 decides whether or not the number of non-isolated blocks having the exposure correction amount smaller than −1.5 is 5 or more. That is, whether or not the image includes a dark portion (area) having a certain size or more is decided.

When it is decided in step S4 that the number of non-isolated blocks having the exposure correction amount smaller than −1.5 is 5 or more, the step proceeds to step S5. That is, according to the processings in step S2 to step S4, whether or not the image capturing scene includes bright portions and dark portions and requires expansion of a dynamic range is decided.

In step S5, the dynamic range composition deciding unit 34 decides whether or not the number of blocks having the exposure correction amount higher than −0.1 and smaller than +0.1 is 10 or less. That is, whether or not an image has little distribution near the adequate exposure value, that is, has little portions which are not obviously bright or dark is decided.

In step S5, when the number of blocks having the exposure correction amount greater than −0.1 and smaller than +0.1 is 10 or less, the step proceeds to step S6, and the light source deciding unit 35 extracts the color temperature of each block based on the average value of R, G and B in each block and decides whether or not the number of non-isolated blocks having the color temperature at 4500 K to 6000 K is 5 or more. That is, whether or not the image includes an area (corresponding to the portion of the blue sky in the images P1 and P2 in FIG. 5) irradiated by sun light is decided.

When it is decided in step S6 that the number of non-isolated blocks having the color temperature at 4500 K to 6000 K is 5 or more, the step proceeds to step S7, and the light source deciding unit 35 decides whether or not the number of non-isolated blocks having the color temperature at 7000 K to 9000 K and having the brightness value Y smaller than 100 is 5 or more. That is, whether or not the image includes the portion (corresponding to a portion such as a building and road in the images P1 and P2 in FIG. 5) irradiated by scattering light due to reflection is decided.

When it is decided in step S7 that the number of non-isolated blocks having the color temperature at 7000 K to 9000 K and the brightness value Y smaller than 100 is 5 or more, that is, when it is decided that the image capturing scene includes bright portions and dark portions, requires expansion of the dynamic range (YES in steps S2 to S4) and includes an area which is irradiated by different light sources (YES in steps S6 and S7), the step proceeds to step S8, and the image capturing control unit 36 decides the image capturing condition of “two-image capturing and multiple white balance composition” based on the decision result by the light source deciding unit 35. Further, the image capturing control unit 36 controls the CMOS sensor 12, strobe 17 and image processing unit 14 according to a mode of “two-image capturing and multiple white balance composition.” By this means, two images are captured at an under exposure and over exposure, white balance processing is applied to the two captured images, and the image of the portion of the blue sky which is captured at the under exposure and to which the white balance is applied and an image of the portion which is captured at the over exposure, to which the white balance is applied and in which there is an object are composed to apply various image processings to the composition image.

By contrast with this, when it is decided in step S7 that the condition that the number of non-isolated blocks having the color temperature at 7000 K to 9000 K and the brightness value Y smaller than 100 is 5 or more cannot be satisfied and when it is decided in step S6 that the condition that the number of non-isolated blocks having the color temperature at 4500 K to 6000 K is 5 or more cannot be satisfied, that is, the image capturing scene includes bright portions and dark portions, requires expansion of the dynamic range (YES in steps S2 to S4) and includes no area which is irradiated by different light sources (NO in steps S6 and S7), the step proceeds to step S9.

In step S9, the image capturing control unit 36 decides the image capturing condition of “two-image capturing and dynamic range expansion” based on the decision result by the light source deciding unit 35. Further, the image capturing control unit 36 controls the CMOS sensor 12, strobe 17 and image processing unit 14 according to a mode of “two-image capturing and dynamic range expansion.” By this means, two images are captured at the under exposure and over exposure, and the image of a bright portion which is captured at the under exposure and the image of the dark portion which is captured at the over exposure are composed to apply various image processings to a composition image.

Further, when it is decided in step S2 that the brightness level of the subject is not 12 Lv or more, when it is decided in step S3 that the number of non-isolated blocks having the exposure correction amount greater than +1.5 is not 15 or more, when it is decided in step S4 that the number of non-isolated blocks having the exposure correction amount smaller than −1.5 is not 5 or more, and when it is decided in step S5 that the number of blocks having the exposure correction amount greater than −0.1 and smaller than +0.1 is not 10 or less, that is, when it is decided that the image capturing scene includes bright portions and dark portions and does not require expansion of the dynamic range (NO in steps S2 to S4), the step proceeds to step S10. That is, when one of the decision conditions in steps S2 to S5 is not satisfied, the step proceeds to step S10.

In step S10, the image capturing control unit 36 decides the image capturing condition of “one-image capturing without composition” based on the decision result of the light source deciding unit 35. Further, the image capturing control unit 36 controls the CMOS sensor 12, strobe 17 and image processing unit 14 according to a mode of “one-image capturing without composition”. By this means, one image is captured, and various image processings are applied to the captured image.

As described above, whether or not the image capturing scene includes bright portions and dark portions and requires expansion of the dynamic range is decided (YES in steps S2 to S4) and, further, whether or not the image capturing scene includes an area which is irradiated by different light sources is decided (YES in steps S6 and S7), and, based on these decision results, processing of expanding the dynamic range and composing the multiple white balances (step S8) or only expanding the dynamic range (step S9) is performed, so that the user can easily obtain an image of an adequate dynamic range and white balance. Further, it is possible to apply adequate white balances to respective light sources, and obtain an image of an adequate white balance at bright portions and dark portions and good reproducibility.

Further, whether or not the dynamic range needs to be expanded is decided according to the distribution amount (content of each block) of bright portions and dark portions (steps S3 and S4 in FIG. 6), so that it is possible to adequately decide the necessity to expand the dynamic range.

Furthermore, whether or not the multiple white balances are composed is decided according to the color temperature of the image (steps S6 and S7 in FIG. 6), so that it is possible to adequately decide whether or not white balances mismatches when the dynamic range is expanded.

Further, whether or not the image includes little portions which are not obviously bright or dark is decided (step 5 in FIG. 6), and, when it is decided that an image is not such an image, the dynamic range is not expanded in case of such an image. With an image having lots of portions which are not obviously bright or dark, the effect cannot be generally provided by expanding the dynamic range, and therefore the dynamic range is not expanded. That is, it is possible to perform efficient image processing.

Further, as described above, the imaging method is decided utilizing the preview image before image capturing (step S1 in FIG. 6), so that it is possible to perform image capturing adequately.

In addition, with the method of expanding the dynamic range and composing multiple white balances illustrated in FIG. 5, a bright area (empty area with this example) is extracted from the image P1 captured at the under exposure, and a dark portion (an area such as a building or road with this example) is extracted from the image P2 captured at the over exposure to compose these images. By contrast with this, it is also possible to generate a final image by composing the bright area extracted from the image P1, with the image P2 captured at the over exposure (that is, by replacing the saturated area in the image P2 with the bright area in the image P1). It is said that a dark portion has a greater information amount of the image. Hence, by so doing, it is possible to maintain the dark image P1 as is.

As described above, although processing of expanding the dynamic range and composing multiple white balances is performed in a digital camera, the above processing of expanding the dynamic range and composing the multiple white balances may be performed in an information processing apparatus (for example, a personal computer) which takes in two images captured at different exposures by a digital camera.

Further, as described above, although the distribution amount of bright portions and dark portions is decided and then the color temperature is decided, it may be possible to first decide the color temperature, determine a threshold of the distribution amount of bright portions and dark portions and decide the distribution amount of bright portions and dark portions based on the determined threshold. By so doing, it is possible to more adequately decide the necessity to expand the dynamic range.

Further, although a case has been described above where an image is captured outdoor, the other conditions are possible as long as an image can be obtained which includes areas irradiated by different light sources and having different brightnesses, and a numerical value (for example, brightness value, the number of blocks and exposure) of the condition illustrated in FIG. 6 is adequately changed depending on a condition.

The above series of processings can be executed by hardware, or can also be executed by software. When a series of processings are executed by software, a computer program configuring this software is installed from a computer program recording medium to a computer integrated in dedicated hardware or, for example, a general-purpose personal computer which can execute various functions by installing various computer programs.

The present invention is by no means limited to the above embodiment, and can be embodied by deforming components within a range without deviating the spirit of the invention at the stage of implementation, and form various inventions by adequately combining a plurality of components disclosed in the above embodiment. For example, some components may be deleted from all components disclosed in the embodiment. Further, components between different embodiments may be adequately combined.

1. An imaging apparatus comprising:
an image sensor;
a deciding unit which decides whether or not a preview image, which is input from the image sensor but is not captured yet, includes an area which is irradiated by different light sources and which comprises different brightnesses, based on a subject brightness and a color temperature of the preview image;
an image capturing control unit which captures two images from the image sensor at different exposures when the deciding unit decides that the preview image includes an area defined above; and
a composition unit which applies a white balance to one image captured at an over exposure, applies a white balance to the other image captured at an under exposure and composes a dark area of the one image captured at the over exposure and applied the white balance to and a bright area of the other image captured at the under exposure and applied the white balance to.

2. The imaging apparatus according to claim 1, wherein the deciding unit decides whether or not to capture and compose two images at the different exposures according to a size of an area of an over exposure and a size of an area of a blocked-up shadow, based on histogram information of the preview image.

3. The imaging apparatus according to claim 1, wherein the deciding unit extracts the color temperature of the preview image, and decides whether or not to perform composition according to a size of an area comprising a color temperature in a predetermined range.

4. An imaging method of an imaging apparatus comprising an image sensor, the method comprising:
deciding whether or not a preview image, which is input from the image sensor but is not captured yet, includes an area which is irradiated by different light sources and which comprises different brightnesses, based on a subject brightness and a color temperature of the preview image;
capturing two images from the image sensor at different exposures when it is decided that the preview image includes an area defined above;
applying a white balance to one image captured at an over exposure;
applying a white balance to the other image captured at an under exposure; and
composing a dark area of the one image captured at the over exposure and applied the white balance to and a bright area of the other image captured at the under exposure and applied the white balance to.

5. A computer program which causes a computer to execute image capturing processing of an imaging apparatus comprising an image capturing element, causing a computer to perform processing comprising:
deciding whether or not a preview image, which is input from the image sensor but is not captured yet, includes an area which is irradiated by different light sources and which comprises different brightnesses, based on a subject brightness and a color temperature of the preview image;
capturing two images from the image sensor at different exposures when it is decided that the preview image includes an area defined above;
applying a white balance to one image captured at an over exposure;
applying a white balance to the other image captured at an under exposure; and
composing a dark area of the one image captured at the over exposure and applied the white balance to and a bright area of the other image captured at the under exposure and applied the white balance to.

6. The imaging apparatus according to claim 2, wherein the deciding unit extracts the color temperature of the preview image, and decides whether or not to perform composition according to a size of an area comprising a color temperature in a predetermined range.
